(19) United States
(12) Patent Application Publication
(10) Pub. No.: US 2008/0029182 A1
(43) Pub. Date: Feb. 7, 2008

(54) Vibration and noise reducing workbench structure

(76) Inventor: Cheng-Kan Wen, Taipei City (TW)

Correspondence Address: TROXELL LAW OFFICE PLLC;SUITE 1404, 5205 LEESBURG PIKE, FALLS CHURCH, VA, 22041, US

(21) Appl. No.: 11/494,606

(22) Filed: Jul. 28, 2006

(51) Int. Cl. B25H 1/00

(52) U.S. Cl. 144/286.5

(57) ABSTRACT

A vibration and noise reducing workbench structure is disclosed. The workbench is a multiplayer structure comprising a metal board, a cushioning layer and a wooden layer stacked upon each other. The metal board is disposed at the top, and the cushioning layer is sandwiched between the metal board and the wooden layer. The presence of a cushioning layer can effectively absorb the vibration and accompanying noise transmitted from the top-layer metal board. As such, lightweight and thinner metal board can be used to lower the production cost and the weight of the entire workbench structure, and the handling of workbench is made easier with the use of less manpower, thereby reducing industrial accidents and costs.

### BACKGROUND OF INVENTION

1. Field of the Invention

The present invention relates to a vibration and noise reducing workbench structure, more particularly a multiplayer structure made of a metal board, a cushioning layer and a wooden layer, in which the presence of the cushioning layer can effectively absorb the vibration and noise transmitted from the top-layer metal board.

2. Description of the Prior Art

The great majority of products, in particular metal products, require certain degree of processing in the manufacturing process. Aside from very large and heavy workpieces that are directly processed on the ground or use a special platform, the processing of most products is carried out on a workbench of proper height for convenience sake. Conventional workbench is mounted on a stand or a base of different shapes. The workbench itself is made of a single layer or two layers consisting of different materials. The material used for the single layer structure varies based on the main purpose of the workbench, which is primarily wood, metal board or granite. Granite has leveled plane, but tends to be brittle and unable to sustain too much impact force. Thus it is used generally in measuring bench, not a processing bench. Wood and metal board are used in processing bench, but each has its merits and disadvantages in application. Wood is light, easy to process and easy to handle, but its surface levelness is difficult to control and wood is prone to deformation when it gets damp. On the other hand, using metal board A of specific thickness as workbench (as shown in FIG. 1) offers the advantages of high levelness, impact resistant and not easy to deform. But it also has the drawbacks of higher cost and heavy weight that makes handling difficult. To address the drawbacks of single-material workbench, some manufacturers introduced workbench structure comprising a metal board B and a wooden layer C (as shown in FIG. 2). By disposing a thin metal board B on wooden layer C, the workbench is impact resistant, leveled and easy to handle. But in the aforesaid products, the metal board B is thin while the surface of wooden layer C not unlikely to be highly leveled. As the uneven-surfaced wooden layer laminates over the highly leveled and rigid metal board B, there are typically gaps D of varying sizes, or we can say air chambers of varying sizes formed between the joint surface. Once the metal board B is under impact in the processing and generates vibration and sound, the sound unavoidably produces guitar-like resonance through the air chambers and generates loud and annoying noise. As the workbench is generally arranged on the surface of a tool cabinet, or a stand with a plurality of cabinets or drawers, the noise generated on the workbench is often multiplied due to the presence of those cabinets or drawers. Aside from the noise problem, vibration produced upon impact will cause varying degrees of harms to the hands of operators if they are subject to it for a long period of time. Thus the aforesaid drawbacks should be addressed with careful consideration.

### SUMMARY OF INVENTION

The primary object of the present invention is to provide a vibration and noise reducing workbench structure which is a three-layer structure made of a metal board, a cushioning layer and a wooden layer stacked upon each other. The cushioning layer is sandwiched between the metal board and the wooden layer, through which vibration and accompanying noise transmitted from the top-layer metal board are effectively absorbed.

Another object of the present invention is to provide a vibration and noise reducing workbench structure, where the cushioning layer disposed between the metal board and the wooden layer would deform properly as the assembly is being compressed under force to fill up the voids on the surface of wooden layer, thereby reducing the unnecessary gaps to prevent the formation of air chambers and the effect of resonance.

A further object of the present invention is that through the reduction of noise and vibration, manufacturers can use thinner metal board or metal board of proper thickness to make processing and handling of workbench more convenient, thereby effectively lowering the costs of processing and handling.

Yet another object of the present invention is to provide a vibration and noise reducing workbench structure, wherein the periphery of the metal board is slightly wider and extends over the outer edges of cushion layer and wooden layer underneath to keep unclean fluids on the workbench surface from flowing along the periphery of metal board onto the cushion layer and wooden layer and contaminate them, which would damp the wooden layer and cause it to swell and deform, or even rot.

To achieve the aforesaid objects, the present invention provides a vibration and noise reducing workbench structure, which is a three-layer structure comprising a metal board, a cushioning layer and a wooden layer stacked upon each other. The metal board is disposed at the top and the wooden layer is disposed at the bottom with the cushioning layer sandwiched therebetween. The presence of a cushioning layer can effectively absorb the vibration and accompanying noise transmitted from the top-layer metal board.

### BRIEF DESCRIPTION OF THE DRAWINGS

The details of the present invention will be more readily understood from a detailed description of the preferred embodiments taken in conjunction with the following figures.

FIG. 1 is a sectional view of a conventional single-layer workbench counter.

FIG. 2A is a sectional view of a conventional dual-layer workbench counter.

FIG. 2B is a magnified view of a part in FIG. 2A.

FIG. 3 is an exploded view of the workbench structure in accordance with the present invention.

FIG. 4 is a sectional view of the workbench structure of the invention.

FIG. 5 is a sectional view of a slot disposed on the bottom surface of metal board of the invention.

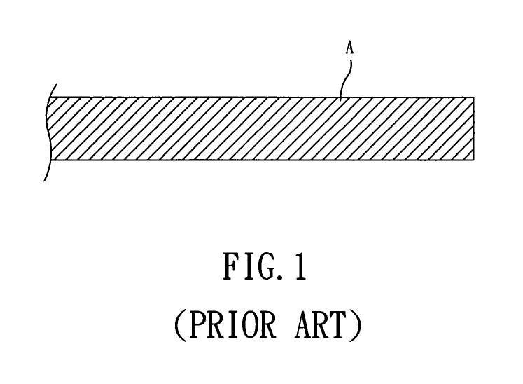

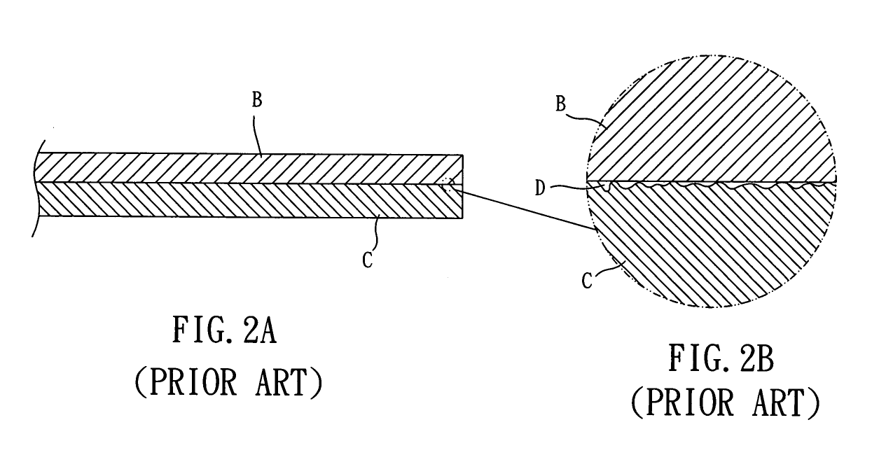

### DETAILED DESCRIPTION

The vibration and noise reducing workbench structure of the invention is depicted more clearly with accompanying drawings. The detailed descriptions below in the examples of workbench are provided to describe the scope of application of the invention. However the vibration and noise reducing workbench of the invention can be applied to other mechanisms that need such a structure (e.g. the top of a tool cabinet) as well. Thus the examples described below are meant to render the description of the invention easier to understand and are not meant to limit the claims of the invention.

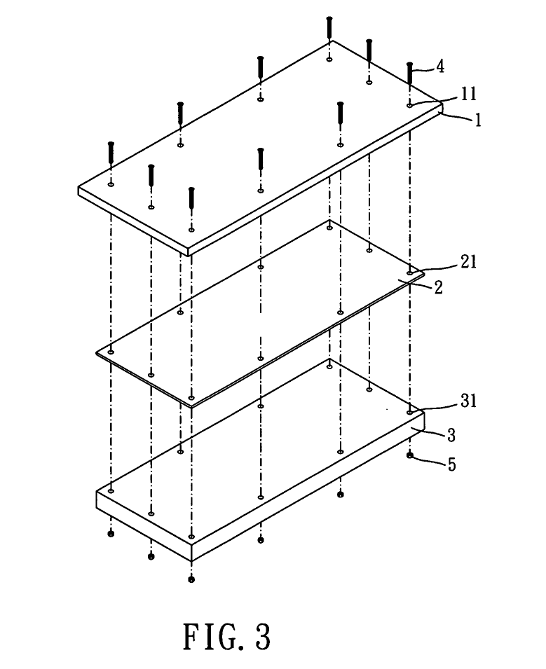

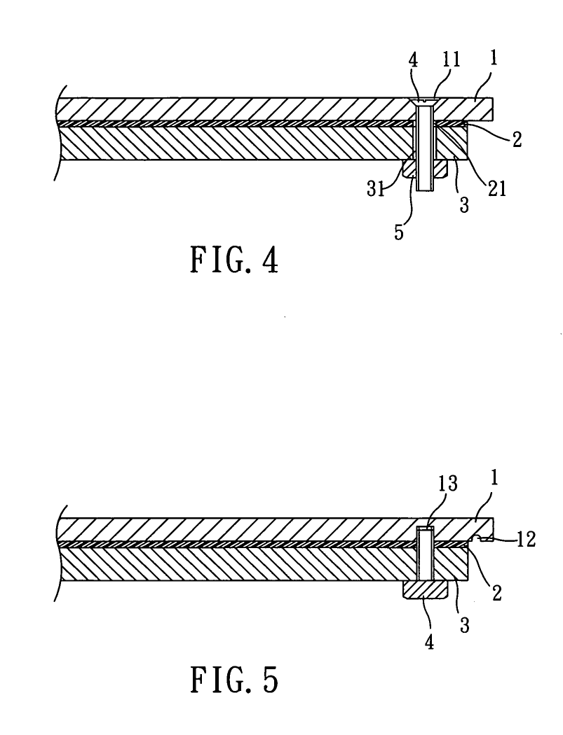

FIG. 3 and FIG. 4 show respectively the exploded view and sectional view of the vibration and noise reducing workbench structure according to a preferred embodiment of the invention. The vibration and noise reducing workbench structure is a three-layer structure comprising a metal board 1, a cushioning layer 2 and a wooden layer 3 stacked upon each other. The metal board 1 is disposed at the top and the wooden layer 3 is disposed at the bottom with the cushioning layer 2 sandwiched therebetween. The presence of a cushioning layer 2 can effectively absorb the vibration and accompanying noise transmitted from the top-layer metal board 1.

In the aforesaid structure, the design of cushioning layer 2 achieves the sound absorption and anti-vibration effect and allows manufacturers to use thinner metal board 1, which not only saves on the material cost, but also reduces the weight of workbench to make its handling easier and save on the cost of manpower needed to move it.

The cushioning layer 2 is made of any elastic material having cushioning effect, e.g. rubber or foam material that can achieve such effect.

The structure of the invention is an assembly made of three different materials, which are securely fastened to each other by all kinds of commonly used means, such as gluing or screw fastening, of which screw fastening is the preferred approach. Screw fastening is achieved by disposing a plurality of through holes 11, 21, 31 on metal board 1, cushioning layer 2, and wooden layer 3 respectively, passing a screw 4 through the through holes 11, 21, 31 on metal board 1, cushioning layer 2, and wooden layer 3, and fastening the screw with a bolt 5 at the other end (as shown in FIG. 3 and FIG. 4) to compress and fasten the three layers tightly together. The aforesaid fastening method not only assembles and fastens three layers of different materials together, the compressing force provided by screw 4 can directly press on the more flexible cushioning layer 2 to cause slight deformation and fill in the minute dents on the surface of wooden layer 3, which reduces the production of unnecessary voids to achieve better contact and vibration absorption effect.

There are a variety of screw fastening methods. Aside from the method of passing a screw 4 through the through holes 11, 21, 31 and then fastening it with a bolt 5, we can also dispose a screw hole 13 at the bottom surface of metal board, and then fasten the screw 4 from the wooden layer 3 at the very bottom upwardly to lock into the screw hole 13 disposed on metal board 1 (as shown in FIG. 5) to achieve the same effect of screw fastening.

The through hole 11 on the metal board 1 allows screw 4 to pass through and fasten. It also allows assembly operator to pass through it a steel cable for convenient and fast handling and lifting of the metal board before screw fastening is performed.

In addition, processing fluids (e.g. lubricant or grinding fluid) might need to be used during processing, which would unavoidably contaminate the top-layer metal board 1. Thus the periphery of the metal board 1 is made wider and extends over the outer edges of cushioning layer 2 and wooden layer 3 underneath, so unclean fluid on the benchtop will not flow along the edges of metal board 1 unto the cushioning layer 2 and wooden layer 3 below. For if it happens, the wooden layer 3 will get damped and then swell and deform, and even rot.

To obtain even better blocking effect, at least a long slot 12 (as shown in FIG. 5) can be configured on the bottom surface of metal board 1 extending over the outer edges of cushioning layer 2 and wooden layer 3 below. With the design of the long slot 12, even if the benchtop has an inclined plane, the unclean fluid on metal board 1 that flows downwards along the outer edges of metal board 1 would be blocked by the long slot 12 due to gravitational force and drip to the ground directly instead of falling on and contaminating the cushioning layer 2 and wooden layer 3 disposed beneath the metal board 1.

The preferred embodiment of the present invention has been disclosed in the example. However the example should not be construed as a limitation on the actual applicable scope of the invention, and as such, all modifications and alterations without departing from the spirits of the invention, for example, changing the fastening structure, shall remain within the protected scope and claims of the invention.

As described above, the disposition of a cushioning layer not only effectively achieves good vibration and noise absorption effect, the designs of protruding rims of the metal board, and long slot at the bottom surface of metal board effectively prevent unclean fluids on the top-layer metal board from contaminating the cushioning layer and wooden layer underneath.

Those skilled in the art will readily observe that numerous modifications and alterations of the device may be made while retaining the teachings of the invention. Accordingly, that above disclosure should be construed as limited only by the metes and bounds of the appended claims.

What is claimed is:

1. A vibration and noise reducing workbench structure that can be mounted on a work table or a tool cabinet, characterized in that the workbench structure is a multi-layered structure comprising a metal board, a cushioning layer and a wooden layer, wherein the metal board is configured at the top, the wooden layer is disposed at the bottom, and the cushioning layer is disposed therebetween.

2. The workbench structure according to claim 1, wherein the cushioning layer is made of an elastic material having cushioning effect.

3. The workbench structure according to claim 2, wherein the cushioning layer is made of pliant or foam material.

4. The workbench structure according to claim 1, wherein different layers of the multi-layered workbench structure are fastened all together by gluing.

5. The workbench structure according to claim 1, wherein different layers of the multi-layered workbench structure are fastened by screw fastening.

6. The workbench structure according to claim 5, wherein a plurality of through holes are disposed on the metal board.

7. The workbench structure according to claim 1, wherein at least one side of the metal board is slightly wider than and extends over the outer edges of cushioning layer and wooden layer underneath.

8. The workbench structure according to claim 7, wherein at least a long slot is configured on the bottom surface of metal board that extends over the outer edges of cushioning layer and wooden layer underneath.
